(19) United States
(12) Patent Application Publication
(10) Pub. No.: US 2025/0004358 A1
(43) Pub. Date: Jan. 2, 2025

(54) WAVELENGTH CONVERTER, LIGHT SOURCE APPARATUS, AND PROJECTOR

(71) Applicant: SEIKO EPSON CORPORATION, Tokyo (JP)

(72) Inventors: Norikazu KADOTANI, Azumino-shi (JP); Kosuke TABAYASHI, Azumino-shi (JP)

(73) Assignee: SEIKO EPSON CORPORATION, Tokyo (JP)

(21) Appl. No.: 18/757,895

(22) Filed: Jun. 28, 2024

(30) Foreign Application Priority Data
Jun. 30, 2023 (JP) 2023-108247

(51) Int. Cl. G03B 21/20; G03B 21/16

(52) U.S. Cl. CPC G03B 21/204; G03B 21/16

(57) ABSTRACT

A wavelength converter according to the present disclosure includes a phosphor irradiated with excitation light, a substrate having a first surface, and a bonding layer that bonds the phosphor to the first surface of the substrate. The bonding layer including an adhesive and a plurality of first fillers mixed with the adhesive, each of the first fillers having a longitudinal axis. The plurality of first fillers are so oriented that a direction along the longitudinal axis of each of the first fillers intersects with the first surface of the substrate. A thermal conductivity of the first fillers is higher than a thermal conductivity of the adhesive.

The present application is based on, and claims priority from JP Application Serial Number 2023-108247, filed Jun. 30, 2023, the disclosure of which is hereby incorporated by reference herein in its entirety.

### BACKGROUND

### 1. Technical Field

The present disclosure relates to a wavelength converter, a light source apparatus, and a projector.

### 2. Related Art

As a light source apparatus used in a projector, there has been a proposed light source apparatus using fluorescence emitted from a phosphor when the phosphor is irradiated with excitation light. To generate bright fluorescence, it is necessary to increase the performance of cooling the phosphor.

JP-A-2020-42236 discloses a technology for efficiently transferring heat of a phosphor to a substrate via fillers having high thermal conductivity and contained in an adhesive that causes the phosphor to adhere to the substrate.

JP-A-2020-42236 is an example of the related art.

However, since the fillers used in the light source apparatus each have a spherical shape, thermal paths are favorably formed in a region where the fillers are close to each other, but it is difficult to efficiently transfer the heat of the phosphor to the substrate in other regions where the thermal paths are blocked. It is conceivable to increase the filling rate of the fillers to readily form the thermal paths, but an increase in the filling rate of the fillers causes reduction in the amount of the adhesive, so that the phosphor may peel off the substrate or may break due to the decrease in the adhesion provided by the adhesive.

### SUMMARY

To solve the problem described above, according to an aspect of the present disclosure, there is provided a wavelength converter including a phosphor irradiated with excitation light, a substrate having a first surface, and a bonding layer that bonds the phosphor to the first surface of the substrate, the bonding layer including an adhesive and a plurality of first fillers mixed with the adhesive, each of the first fillers having a longitudinal axis. The plurality of first fillers are so oriented that a direction along the longitudinal axis of each of the first fillers intersects with the first surface of the substrate. A thermal conductivity of the first fillers is higher than a thermal conductivity of the adhesive.

According to another aspect of the present disclosure, there is provided a light source apparatus including the wavelength converter according to the aspect described above, and an excitation light source that outputs the excitation light toward the wavelength converter.

According to another aspect of the present disclosure, there is provided a projector including the light source apparatus according to the aspect described above, a light modulator that modulates light emitted from the light source apparatus, and a projection optical apparatus that projects the light modulated by the light modulator.

### BRIEF DESCRIPTION OF THE DRAWINGS

FIG. 1 is a schematic configuration diagram of a projector according to a first embodiment.

FIG. 2 is a schematic configuration diagram showing a light source apparatus according to the first embodiment.

FIG. 3 is a cross-sectional view showing the configurations of key parts of a bonding layer in the first embodiment.

FIG. 4 is an enlarged view showing the configurations of key parts of the wavelength converter according to a second embodiment.

FIG. 5 is an enlarged view showing the configurations of key parts of the wavelength converter according to a third embodiment.

FIG. 6 is an enlarged view showing the configurations of key parts of the wavelength converter according to a fourth embodiment.

FIG. 7 is an enlarged view showing the configurations of key parts of the wavelength converter according to a fifth embodiment.

FIG. 8 is an enlarged view showing the configurations of key parts of the wavelength converter according to a sixth embodiment.

FIG. 9 is an enlarged view showing the configurations of key parts of the wavelength converter according to a seventh embodiment.

### DESCRIPTION OF EMBODIMENTS

Embodiments of the present disclosure will be described below in detail with reference to the drawings. In the drawings used in the description below, a characteristic portion is enlarged for convenience in some cases for clarity of the characteristic thereof, and the dimension ratio and other factors of each component are therefore not always equal to actual values.

### First Embodiment

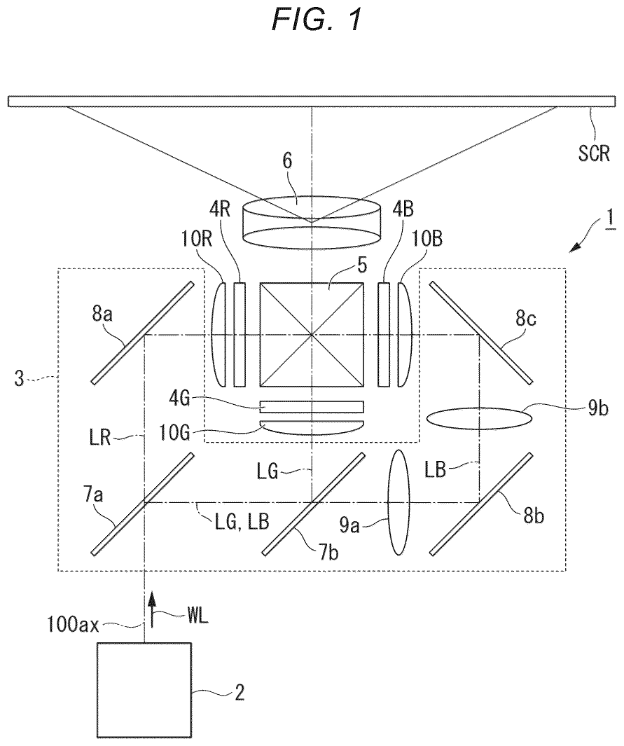

FIG. 1 is a schematic configuration diagram of a projector according to the present embodiment.

A projector 1 according to the present embodiment is a projection-type image display apparatus that displays video images on a screen SCR, as shown in FIG. 1. The projector 1 includes a light source apparatus 2, a color separation system 3, light modulators 4R, 4G, and 4B, a light combining system 5, and a projection optical apparatus 6.

The light source apparatus 2 outputs white illumination light WL toward the color separation system 3. The configuration of the light source apparatus 2 will be described later in detail.

The color separation system 3 separates the illumination light WL output from the light source apparatus 2 into red light LR, green light LG, and blue light LB. The color separation system 3 includes a first dichroic mirror 7a, a second dichroic mirror 7b, a first total reflection mirror 8a, a second total reflection mirror 8b, a third total reflection mirror 8c, a first relay lens 9a, and a second relay lens 9b.

The first dichroic mirror 7a separates the illumination light WL from the light source apparatus 2 into the red light LR and light containing the green light LG and the blue light LB. The first dichroic mirror 7a transmits the red light LR and reflects the light containing the green light LG and the blue light LB. On the other hand, the second dichroic mirror 7b reflects the green light LG and transmits the blue light LB. The second dichroic mirror 7b thus separates the light containing the green light LG and the blue light LB into the green light LG and the blue light LB.

The first total reflection mirror 8a is disposed in the optical path of the red light LR and reflects the red light LR having passed through the first dichroic mirror 7a toward the light modulator 4R. On the other hand, the second total reflection mirror 8b and the third total reflection mirror 8c are disposed in the optical path of the blue light LB and guide the blue light LB having passed through the second dichroic mirror 7b to the light modulator 4B. The green light LG is reflected off the second dichroic mirror 7b toward the light modulator 4G.

The first relay lens 9a and the second relay lens 9b are disposed in the optical path of the blue light LB on the light exiting side of the second total reflection mirror 8b. The first relay lens 9a and the second relay lens 9b compensate for optical loss of the blue light LB resulting from the fact that the optical path length of the blue light LB is longer than the optical path lengths of the red light LR and the green light LG.

The light modulator 4R modulates the red light LR in accordance with image information to form image light corresponding to the red light LR. The light modulator 4G modulates the green light LG in accordance with image information to form image light corresponding to the green light LG. The light modulator 4B modulates the blue light LB in accordance with image information to form image light corresponding to the blue light LB.

The light modulators 4R, 4G, and 4B are each, for example, a transmissive liquid crystal panel. Polarizers that are not shown are disposed at the light incident and exiting sides of each of the liquid crystal panels.

A field lens 10R is disposed at the light incident side of the light modulator 4R. The field lens 10R parallelizes the red light LR to be incident on the light modulator 4R. A field lens 10G is disposed at the light incident side of the light modulator 4G. The field lens 10G parallelizes the green light LG to be incident on the light modulator 4G. A field lens 10B is disposed at the light incident side of the light modulator 4B. The field lens 10B parallelizes the blue light LB to be incident on the light modulator 4B.

The image light output from the light modulator 4R, the image light output from the light modulator 4G, and the image light output from the light modulator 4B enter the light combining system 5. The light combining system 5 combines the image light corresponding to the red light LR, the image light corresponding to the green light LG, and the image light corresponding to the blue light LB with one another and outputs the combined image light toward the projection optical apparatus 6. The light combining system 5 is, for example, a cross dichroic prism.

The projection optical apparatus 6 includes a plurality of projection lenses. The projection optical apparatus 6 enlarges the combined image light from the light combining system 5 and projects the enlarged image light toward the screen SCR. Enlarged video images are thus displayed on the screen SCR.

The configuration of the light source apparatus 2 will be described below.

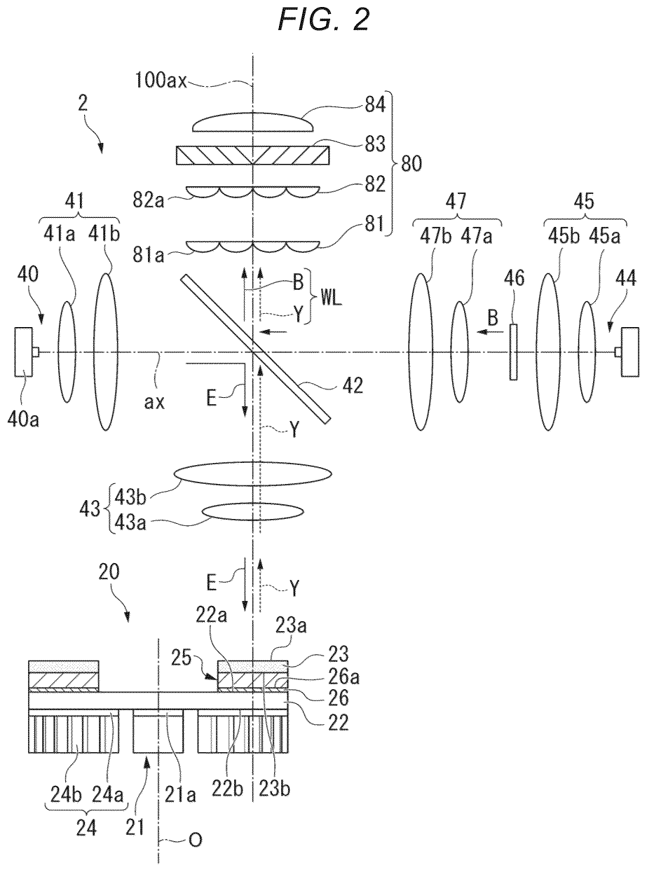

FIG. 2 is a schematic configuration diagram showing the light source apparatus 2 according to the present embodiment.

The light source apparatus 2 includes a first light source 40, a collimation system 41, a dichroic mirror 42, a light collimation and collection system 43, a wavelength converter 20, a second light source 44, a light collection system 45, a diffuser 46, and a collimation system 47, as shown in FIG. 2.

The first light source 40 is an excitation light source that radiates excitation light E toward the wavelength converter 20. The first light source 40 is formed of a semiconductor laser 40a, which outputs the excitation light E formed of blue laser light. The intensity of the output excitation light E peaks, for example, at a wavelength of about 445 nm. The semiconductor laser 40a can instead be a semiconductor laser that outputs blue light having a wavelength other than 445 nm, for example, blue light having a wavelength of 455 nm or 460 nm. An optical axis ax of the first light source 40 is perpendicular to an illumination optical axis 100ax of the light source apparatus 2. Note that the first light source 40 may be formed of a plurality of semiconductor lasers 40a arranged in an array in a plane perpendicular to the optical axis ax of the first light source 40.

The collimation system 41 includes a first lens 41a and a second lens 41b. The collimation system 41 substantially parallelizes the light output from the first light source 40. The first lens 41a and the second lens 41b are each formed of a convex lens.

The dichroic mirror 42 is disposed in the optical path between the collimation system 41 and the light collimation and collection system 43 and oriented so as to intersect with the optical axis ax of the first light source 40 and the illumination optical axis 100ax at an angle of 45°. The dichroic mirror 42 reflects a blue light component and transmits a red light component and a green light component. The dichroic mirror 42 therefore reflects the excitation light E and blue light B, the latter of which will be described later, and transmits yellow fluorescence Y.

The light collimation and collection system 43 collects the excitation light E reflected off the dichroic mirror 42 and causes the collected excitation light E to enter the wavelength converter 20 and also substantially parallelizes the fluorescence Y, which is emitted from the wavelength converter 20. The light collimation and collection system 43 includes a first lens 43a and a second lens 43b. The first lens 43a and the second lens 43b are each formed of a convex lens.

The second light source 44 is formed of a semiconductor laser that outputs light having a wavelength band that is the same as that of the light output from the first light source 40. The second light source 44 may be formed of one semiconductor laser or a plurality of semiconductor lasers. The second light source 44 may instead be formed of a semiconductor laser that outputs light having a wavelength band different from the wavelength band of the light output from the semiconductor laser of the first light source 40.

The light collection system 45 includes a first lens 45a and a second lens 45b. The light collection system 45 collects the blue light B output from the second light source 44 on or in the vicinity of a diffusion surface of the diffuser 46. The first lens 45a and the second lens 45b are each formed of a convex lens.

The diffuser 46 diffuses the blue light B output from the second light source 44 to generate blue light B having a light orientation distribution close to the light orientation distribution of the fluorescence Y emitted from the wavelength converter 20. The diffuser 46 can be formed, for example, of a ground glass plate made of optical glass.

The collimation system 47 includes a first lens 47a and a second lens 47b. The collimation system 47 substantially parallelizes the light output from the diffuser 46. The first lens 47a and the second lens 47b are each formed of a convex lens.

The blue light B output from the second light source 44 is reflected off the dichroic mirror 42 and combined with the fluorescence Y having been emitted from the wavelength converter 20 and having passed through the dichroic mirror 42 into the white illumination light WL. The illumination light WL enters a uniform illumination system 80.

The uniform illumination system 80 includes a first lens array 81, a second lens array 82, a polarization converter 83, and a superimposing lens 84.

The first lens array 81 includes a plurality of first lenses 81a, which divide the illumination light WL from the light source apparatus 2 into a plurality of sub-luminous fluxes. The plurality of first lenses 81a are arranged in a matrix in a plane perpendicular to the illumination optical axis 100ax.

The second lens array 82 includes a plurality of second lenses 82a corresponding to the plurality of first lenses 81a in the first lens array 81. The plurality of second lenses 82a are arranged in a matrix in a plane perpendicular to the illumination optical axis 100ax.

The second array 82 along with the superimposing lens 84 brings images of the first lenses 81a of the first lens array 81 into focus in the vicinity of an image formation region of each of the light modulators 4R, 4G, and 4B.

The polarization converter 83 converts the light output from the second lens array 82 into one kind of linearly polarized light. The polarization converter 83 includes, for example, polarization separation films and retardation films (not shown).

The superimposing lens 84 collects the sub-luminous fluxes output from the polarization converter 83 and superimposes the collected sub-luminous fluxes on one another in the vicinity of the image formation region of each of the light modulators 4R, 4G, and 4B.

The configuration of the wavelength converter 20 will next be described.

The wavelength converter 20 includes a rotation driver 21, a wheel substrate 22, a phosphor 23, a heat dissipation member 24, and a bonding layer 25.

The rotation driver 21 is formed of a motor apparatus. The rotation driver 21 includes a rotary shaft 21a, which is rotatable around an axis of rotation O, which is an imaginary axis. The rotary shaft 21a rotatably supports the wheel substrate 22.

The wheel substrate 22 has a front surface 22a as a first surface and a rear surface 22b as a second surface opposite from the first surface. The wheel substrate 22 is formed of a disk-shaped or annular plate made of metal that excels in heat dissipation, for example, aluminum and copper.

The phosphor 23 is provided at the front surface 22a of the wheel substrate 22.

The phosphor 23 is formed in an annular shape around the axis of rotation O at the front surface 22a of the wheel substrate 22. That is, the phosphor 23 is provided in a ring-like shape around the axis of rotation O.

The phosphor 23 generates heat when emitting the fluorescence Y. When the temperature of the phosphor 23 becomes too high, the efficiency at which the excitation light E is converted in terms of wavelength into the fluorescence Y may decrease, and the amount of emitted fluorescence Y may therefore decrease. The wavelength converter 20 according to the present embodiment, in which the phosphor 23 rotates along with the wheel substrate 22, allows the position where the excitation light E is incident on the phosphor 23 to be moved with time. Thus increasing the performance of cooling the phosphor 23 suppresses a decrease in the fluorescence conversion efficiency due to an increase in the temperature of the phosphor 23.

The phosphor 23 converts the excitation light E radiated via an upper surface 23a thereof in terms of wavelength into the fluorescence Y and emits the fluorescence Y via the upper surface 23a. The phosphor 23 is a wavelength conversion member containing a ceramic phosphor formed of a polycrystalline phosphor. The wavelength band of the fluorescence Y is, for example, a yellow wavelength band ranging from 490 to 750 nm. That is, the fluorescence Y is yellow fluorescence containing a red light component and a green light component.

The phosphor 23 may contain a single crystal phosphor in place of a polycrystalline phosphor. Still instead, the phosphor 23 may be formed of a binder which is made of glass or resin and in which a large number of phosphor particles are dispersed.

Specifically, the material of the phosphor 23 in the present embodiment contains, for example, an yttrium-aluminum-garnet-based (YAG-based) phosphor. Consider YAG:Ce, which contains cerium (Ce) as an activator, by way of example, and the phosphor 23 is made, for example, of a material produced by mixing raw powder materials containing Y₂O₃, Al₂O₃, CeO₃, and other constituent elements with one another and causing the mixture to undergo a solid-phase reaction, Y—Al—O amorphous particles produced by using a coprecipitation method, a sol-gel method, or any other wet method, or YAG particles produced by using a spray-drying method, a flame-based thermal decomposition method, a thermal plasma method, or any other gas-phase method.

The bonding layer 25 bonds the phosphor 23 to the front surface 22a of the wheel substrate 22. The wheel substrate 22 has a reflection surface 26a, which is in contact with the bonding layer 25 and reflects light. The reflection surface 26a reflects the light having exited via a rear surface 23b of the phosphor 23 and passed through the bonding layer 25 toward the upper surface 23a. The fluorescence is thus extracted at increased efficiency via the upper surface 23a of the phosphor 23.

In the present embodiment, the reflection surface 26a is formed of the surface of a reflection layer 26 provided between the bonding layer 25 and the front surface 22a of the wheel substrate 22. The reflection layer 26 is formed of a film produced by deposition of Al, Ag, or any other highly reflective substance. In the present embodiment, the reflection layer 26 is formed of an Ag film having a high reflectance. When the front surface 22a of the wheel substrate 22 has light reflectivity, a part of the front surface 22a may be used as the reflection surface.

The heat dissipation member 24 constitutes a heat sink including a base 24a and a plurality of heat dissipation fins 24b. The base 24a is formed of a circular plate made of metal that excels in heat dissipation, for example, aluminum and copper. The base 24a has an outer shape that is the same as that of the wheel substrate 22, and is bonded to the rear surface 22b of the wheel substrate 22. The plurality of heat dissipation fins 24b are located in a region radially outward from the rotation driver 21 and extend radially in all directions toward the outer edge of the base 24a.

The heat of the wheel substrate 22 is transferred to the base 24a of the heat dissipation member 24. The heat dissipation member 24 rotates around the axis of rotation o along with the wheel substrate 22 to generate an airflow between the plurality of heat dissipation fins 24b, thereby dissipating the heat of the base 24a. The heat dissipation member 24 thus dissipates the heat of the wheel substrate 22.

In the wavelength converter 20, the heat of the phosphor 23 is transferred to the bonding layer 25 and then to the wheel substrate 22 via the bonding layer 25.

The present inventors have focused on the fact that the heat of the phosphor 23 can be efficiently transferred to the wheel substrate 22 by favorably forming thermal paths extending from the phosphor 23 toward the wheel substrate 22 in the bonding layer 25. The present inventors have then attained the configuration of the bonding layer 25 of the wavelength converter 20 according to the present embodiment.

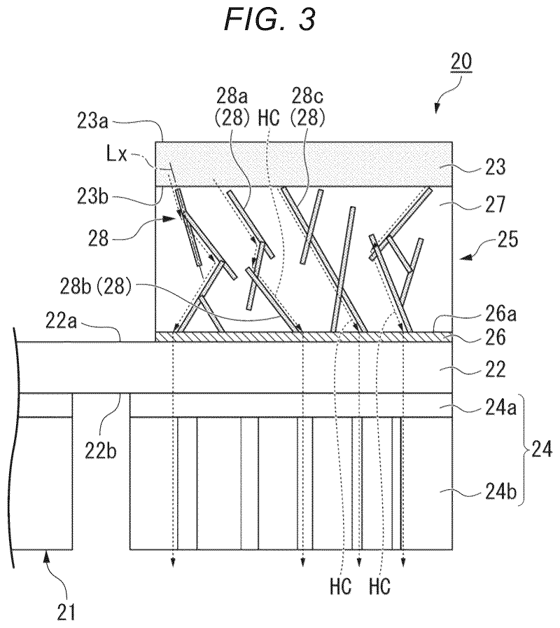

FIG. 3 is an enlarged cross-sectional view showing the configurations of key parts of the bonding layer 25.

The bonding layer 25 in the present embodiment includes an adhesive 27 and a plurality of first fillers 28 mixed with the adhesive 27, as shown in FIG. 3. The thickness of the bonding layer 25 is desirably set at a value ranting from 10 μm to 20 μm.

The plurality of first fillers 28 each have a rod-like shape. The rod-like shape used herein is a shape extending in one direction, and may be an elongated spherical shape having an elliptical cross section, or may be a needle-like shape having pointed opposite ends. The first fillers 28 each having a rod-like shape therefore each have a longitudinal axis Lx along the longitudinal direction.

The plurality of first fillers 28 are each oriented in a direction in which the direction along the longitudinal axis Lx intersects with the front surface 22a of the wheel substrate 22. That is, the plurality of first fillers 28 are not parallel to but incline with respect to the front surface 22a of the wheel substrate 22 and are contained in the adhesive 27. The first fillers 28 disposed in the adhesive 27 are therefore so oriented that the longitudinal axis Lx extends along the thickness direction of the bonding layer 25.

The plurality of first fillers 28, each of which have a rod-like shape, overlap with each other in layers in the adhesive 27 to form a fibrous shape as a whole, as shown in FIG. 3. That is, it can be in other words said that the bonding layer 25 in the present embodiment is formed of the adhesive 27 and the plurality of first fillers 28 having a fibrous shape.

In the present embodiment, the plurality of first fillers 28 include fillers 28a in contact with the phosphor 23 and fillers 28b in contact with the wheel substrate 22. Specifically, the fillers 28a are in contact with the rear surface 23b of the phosphor 23, and the fillers 28b are in indirect contact with the front surface 22a of the wheel substrate 22 via the reflection layer 26.

In the present embodiment, the plurality of first fillers 28 include long fillers 28c. One end of each of the long fillers 28c is in contact with the rear surface 23b of the phosphor 23, and the other end is in contact with the reflection surface 26a.

The first fillers 28 each having a rod-like shape or having a fibrous shape are preferably made of a material that excels in thermal conductivity, for example, titanium oxide, alumina (Al₂O₃), carbon, carbon nanotubes, boron nitride (BN), and BN nanotubes. Table 1 below shows data on the physical properties of the candidate materials of the fillers. Table 1 further shows the physical properties of the filler material that will be described later.

TABLE 1

| | | | Light | Thermal |
|---|---|---|---|---|
| | | | reflectance | conductivity |
| Filler material | Shape | Size (μm) | (%) | (W / m · k) |
| Titanium oxide | Spherical shape, | Several microns | 90 to 98% | from 7.5 to 10.5 |
| | needle-like shape | to several tens of | | |
| | | microns | | |
| Alumina (Al₂O₃) | Spherical shape, | Several microns | 90% | 20 |
| | needle-like shape, | to several tens of | | |
| | plate shape | microns | | |
| Boron Nitride | Spherical shape, | 1 μm or smaller | 95% | 200 or greater |
| (BN) | plate shape | | | |
| BN nanotubes | Needle-like shape | Several microns | 95% | About 3000 |
| Carbon | Needle-like shape, | 50 μm | 5% or | 2000 or smaller |
| | fibrous shape | | smaller | |
| Carbon | Needle-like shape | 1 μm or smaller | 5% or | from 3000 to |
| nanotubes (CNT) | | | smaller | 6000 |

The fillers made of titanium oxide have an average particle diameter of several to several tens of microns, a light reflectance ranging from 90 to 98%, and thermal conductivity ranging from 7.5 to 10.5 W/m·Ks, as shown in Table 1. The fillers made of alumina (Al₂O₃) have an average particle diameter ranging several to several tens of microns, a light reflectance of 90%, and thermal conductivity of 20 W/m·K. The fillers made of boron nitride (BN) have an average particle diameter of 1 μm or smaller, a light reflectance of 95%, and thermal conductivity of 200 W/m·K. The fillers formed of BN nanotubes have an average particle diameter of several microns, a light reflectance of 95%, and thermal conductivity of about 3000 W/m·K. The fillers made of carbon have an average particle diameter of 50 μm, a light reflectance of 5% or smaller, and thermal conductivity of 2000 W/m·K or lower. The fillers formed of carbon nanotubes have an average particle diameter of 1 μm or smaller, a light reflectance of 5% or smaller, and thermal conductivity ranging from 3000 to 6000 W/m·K or lower.

In the present embodiment, the adhesive 27 is made of a resin material having light transparency, for example, silicone resin. The adhesive 27 made of silicone resin has thermal conductivity of about 0.15 W/m·K.

In the bonding layer 25 in the present embodiment, the thermal conductivity of the first fillers 28 is higher than the thermal conductivity of the adhesive 27.

The effects of the wavelength converter 20 according to the present embodiment will be subsequently described. In FIG. 3, thermal paths HC, which are paths of heat transferred from the phosphor 23 to the wheel substrate 22, are indicated with broken lines for clarity of the description.

In the wavelength converter 20 according to the present embodiment, the heat of the phosphor 23 is transferred via the rear surface 23b of the phosphor 23 to the bonding layer 25. The heat of the phosphor 23 is first transferred to the fillers closest to the rear surface 23b among the plurality of first fillers 28. In the present embodiment, the heat of the phosphor 23 is transferred to the fillers 28a in contact with the rear surface 23b.

In the bonding layer 25 in the present embodiment, since the longitudinal axis Lx of each of the first fillers 28 extends along the thickness direction of the bonding layer 25, some of the plurality of first fillers 28 are in contact with each other and arranged in line in the thickness direction of the bonding layer 25. The heat of the fillers 28a is therefore transferred to the first fillers 28 in contact with the fillers 28a, and eventually transferred to the first fillers 28 closest to the wheel substrate 22. In the present embodiment, the heat of the phosphor 23 is transferred to the fillers 28b in contact with the reflection surface 26a of the wheel substrate 22, and is then transferred to the wheel substrate 22 via the reflection layer 26. That is, the bonding layer 25 forms the thermal paths HC, along which the heat of the phosphor 23 is transferred to the wheel substrate 22 via the plurality of first fillers 28 arranged in line in the thickness direction, so that the heat of the phosphor 23 can be efficiently dissipated out of the wheel substrate 22.

Furthermore, in the embodiment, since one end of each of the long fillers 28c is in contact with the rear surface 23b of the phosphor 23, and the other end is in contact with the reflection surface 26a, the long fillers 28c alone can form the thermal paths HC in the bonding layer 25.

The thermal paths HC from the phosphor 23 to the wheel substrate 22 are preferably so configured that the plurality of first fillers 28 are in contact with each other throughout the thermal paths HC from the rear surface 23b of the phosphor 23 to the reflection surface 26a. However, even when some of the plurality of first fillers 28 are not in contact with each other, the first fillers 28 are still effective because the first fillers 28 have thermal conductivity higher than that of spherical fillers in the related art.

In the bonding layer 25 in the present embodiment, since the plurality of first fillers 28 overlap with each other in layers in the adhesive 27 to form a fibrous shape as a whole as described above, a plurality of similar thermal paths HC are formed in the bonding layer 25, as shown in FIG. 3.

The heat of the phosphor 23 is thus transferred to the wheel substrate 22 via the bonding layer 25, and the heat transferred to the wheel substrate 22 is dissipated via the heat dissipation member 24.

To achieve the fibrous form, note that the plurality of first fillers do not each necessarily have a rod-like shape, and a plurality of thread-shaped first fillers may be entangled with each other. In this case, the plurality of first fillers curved and entangled with each other can form the thermal paths to provide the same effect.

It is preferable in the present embodiment that the reflectance of the first fillers 28 is higher than the reflectance of the adhesive 27. Specifically, when any of titanium oxide, alumina (Al₂O₃), boron nitride (BN), and BN nanotubes shown in Table 1 described above is used as the material of the first fillers 28, the reflectance of the first fillers 28 can be made higher than the reflectance of the adhesive 27.

According to the configuration described above, the first fillers 28 not only constitute thermal paths that will be described later, but also reflect the fluorescence Y along with the reflection surface 26a, thereby enhancing the efficiency at which the fluorescence Y is extracted.

### Effects of First Embodiment

The wavelength converter 20 according to the present embodiment includes the phosphor 23 irradiated with the excitation light E, the wheel substrate 22 having the front surface 22a, and the bonding layer 25, which bonds the phosphor 23 to the front surface 22a of the wheel substrate 22.

The bonding layer 25 includes the adhesive 27 and the plurality of first fillers 28 mixed with the adhesive 27 and each having the longitudinal axis Lx. The plurality of first fillers 28 are oriented in a direction in which the direction along the longitudinal axis Lx intersects with the front surface 22a of the wheel substrate 22, and the thermal conductivity of the first fillers 28 is greater than that of the adhesive 27.

In the wavelength converter 20 according to the present embodiment, the bonding layer 25 is formed of the adhesive 27 and the plurality of first fillers 28 mixed with the adhesive 27 and each having a rod-like shape or having a fibrous shape, the thermal conductivity of the first fillers 28 is higher than that of the adhesive 27, and the plurality of first fillers 28 constitute the thermal paths HC, along which the heat of the phosphor 23 is transferred to the wheel substrate 22.

In the wavelength converter 20 according to the present embodiment, the plurality of first fillers 28 can form the thermal paths HC, which extend from the phosphor 23 toward the wheel substrate 22, in the bonding layer 25.

When thermal paths are formed in the bonding layer by increasing the filling rate of the spherical fillers as in the related art, the amount of the adhesive decreases, which may lower the strength of adhesion provided by the bonding layer, so that the phosphor may peel off the bonding layer or break.

In contrast, the bonding layer 25 in the present embodiment, in which the thermal paths HC are efficiently formed by aligning the orientation of the longitudinal axis Lx of each of the rod-shaped first fillers 28 with the thickness direction of the bonding layer 25, can provide a sufficient bonding strength without reduction in the amount of the adhesive.

The wavelength converter 20 according to the present embodiment, in which the phosphor 23 is stably held and efficiently cooled, can therefore increase the wavelength conversion efficiency of the phosphor 23 to generate bright fluorescence Y.

The light source apparatus 2 according to the present embodiment includes the wavelength converter 20 and the first light source 40, which serves as the excitation light source that radiates the excitation light E toward the wavelength converter 20.

The light source apparatus 2 according to the embodiment can be a light source apparatus that excels in the wavelength conversion efficiency and outputs the illumination light WL containing the bright fluorescence Y.

The projector 1 according to the present embodiment includes the light source apparatus 2, the light modulators 4R, 4G, and 4B, which modulate the illumination light WL output from the light source apparatus 2 and containing the fluorescence Y, and the projection optical apparatus 6, which projects the light modulated by the light modulators 4R, 4G, and 4B.

The projector 1 according to the present embodiment can be a highly efficient projector that excels in display quality.

### Second Embodiment

The wavelength converter according to a second embodiment will be described below.

The basic configuration of the wavelength converter according to the second embodiment is the same as that in the first embodiment, but the configuration of the bonding layer differs from that in the first embodiment. The configuration of the bonding layer will therefore be primarily described below.

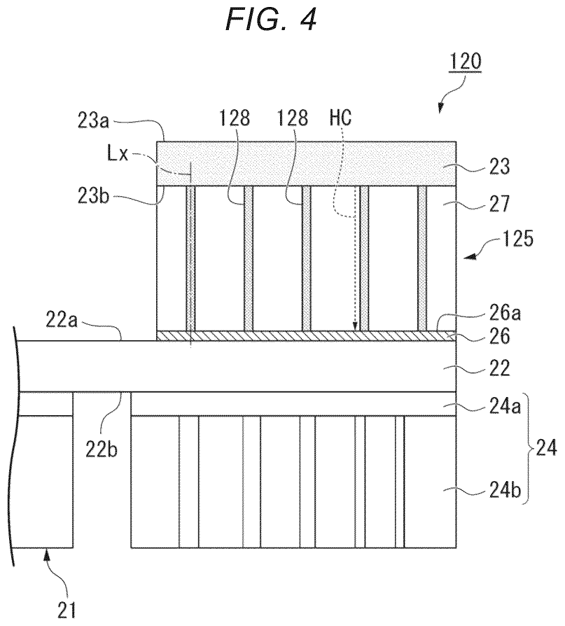

FIG. 4 is an enlarged view showing the configurations of key parts of a wavelength converter 120 according to the present embodiment. In FIG. 4, components common to those in the figures used in the embodiment described above have the same reference characters and will not be described.

The wavelength converter 120 includes the rotation driver 21, the wheel substrate 22, the phosphor 23, the heat dissipation member 24, and a bonding layer 125, as shown in FIG. 4.

The bonding layer 125 in the present embodiment includes the adhesive 27 and a plurality of first fillers 128 mixed with the adhesive 27. The plurality of first fillers 128 each have a rod-like shape having the longitudinal axis Lx.

The plurality of first fillers 128 are provided upright at the front surface 22a of the wheel substrate 22 or the rear surface 23b of the phosphor 23, which is the surface facing the wheel substrate 22. In the present embodiment, the plurality of first fillers 128 are so arranged, for example, through electrostatic planting that the longitudinal axis Lx is substantially perpendicular to the front surface 22a and the rear surface 23b. Furthermore, the lengths of the first fillers 128 are made substantially equal to each other in the present embodiment. Specifically, the length of the first fillers 128 is made equal to the thickness of the adhesive 27.

In the wavelength converter 120 according to the present embodiment, the lengths of the thermal paths HC formed by the first fillers 128 in the bonding layer 125 can be minimized. Furthermore, making the lengths of the first fillers 128 substantially equal to each other allows the thickness of the adhesive 27 to be controlled by the length of the first fillers 128. When the thickness of the bonding layer 125 is thus made uniform, the phosphor 23 can be stably held, and variation in the in-plane heat dissipation characteristics of the phosphor 23 can be suppressed.

### Third Embodiment

The wavelength converter according to a third embodiment will be described below.

The basic configuration of the wavelength converter according to the third embodiment is the same as that in the first embodiment, but the configuration of the bonding layer differs from that in the first embodiment. The configuration of the bonding layer will therefore be primarily described below.

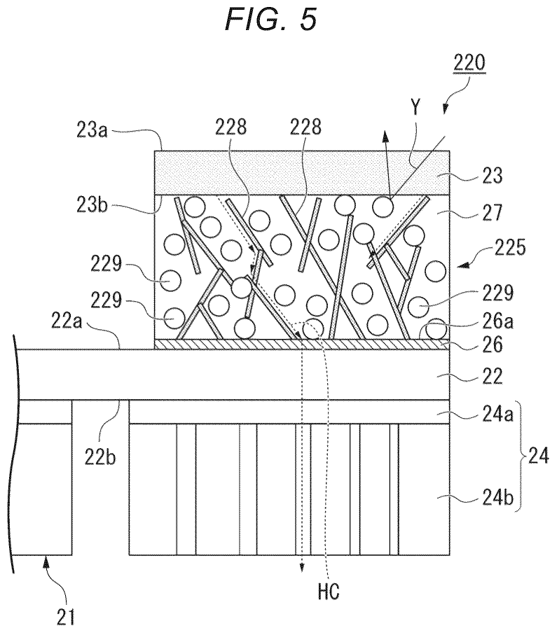

FIG. 5 is an enlarged view showing the configurations of key parts of a wavelength converter 220 according to the present embodiment. In FIG. 5, components common to those in the figures used in the embodiments described above have the same reference characters and will not be described.

The wavelength converter 220 includes the rotation driver 21, the wheel substrate 22, the phosphor 23, the heat dissipation member 24, and a bonding layer 225, as shown in FIG. 5.

The bonding layer 225 in the present embodiment includes the adhesive 27, a plurality of first fillers 228, and a plurality of second fillers 229 having a reflectance higher than that of the first fillers 228. The plurality of second fillers 229 each have a spherical shape.

The plurality of first fillers 228 each have a rod-like shape, are not parallel to but incline with respect to the front surface 22a of the wheel substrate 22, and are contained in the adhesive 27, as in the case of the first fillers 28 in the first embodiment. The plurality of first fillers 228 overlap with each other in layers in the adhesive 27 to form a fibrous shape as a whole.

In the present embodiment, for example, carbon or carbon nanotubes shown in Table 1 can be used as the high-thermal-conductivity material of the first fillers 228. Carbon or carbon nanotubes have extremely high thermal conductivity, but are blackish and absorb light, and therefore have a low reflectance of 5% or lower. Therefore, the first fillers 228 increase the thermal conductivity of the bonding layer 225, while causing a decrease in light reflectivity.

In contrast, in the present embodiment, the material of the second fillers 229 can be a material having a high reflectance, for example, titanium oxide, alumina (Al₂O₃), and zinc oxide shown in Table 1 described above. The plurality of second fillers 229 each have a spherical shape.

Mixing the spherical second fillers 229 with the rod-shaped first fillers 228 as described above allows reflection of the light in a variety of directions, so that the light reflectance inside the bonding layer 225 can be further improved. Some of the plurality of second fillers 229 are disposed in the adhesive 27 so as to be in contact with some of the first fillers 228. In the bonding layer 225 in the present embodiment, in which some of the first fillers 228 and second fillers 229 are in contact with each other, thermal paths in the thickness direction are readily formed. The material of the second fillers 229 may, for example, be beryllium oxide (BeO) having high thermal conductivity of 250 W/m·K while having light reflectivity.

In the bonding layer 225 in the present embodiment, the content rate of the first fillers 228 is smaller than the that of the second fillers 229. The content of the first fillers 228 with respect to the entire bonding layer 225 is preferably 40 vol % or smaller, and the total amount of fillers that is the combination of the first fillers 228 and the second fillers 229 with respect to the entire bonding layer 225 is preferably 80 vol % or smaller. Mixing the first fillers 228 and the second fillers 229 with each other at a ratio that falls within the range described above can achieve the bonding layer 225 that excels in thermal conductivity and light reflectivity and has sufficient bonding strength.

In the thus configured wavelength converter 220 according to the present embodiment, the plurality of first fillers 228 having excellent thermal conductivity ensure the thermal paths HC, and mixing the second fillers 229 having a high reflectance with the first fillers 228 allows an increase in the efficiency at which the fluorescence Y is extracted.

The wavelength converter 220 according to the present embodiment, which efficiently extracts the fluorescence, can therefore generate bright illuminator light.

### Fourth Embodiment

The wavelength converter according to a fourth embodiment will be described below.

The basic configuration n of the wavelength converter according to the fourth embodiment is the same as that in the third embodiment, but the configuration of the bonding layer differs from that in the third embodiment. The configuration of the bonding layer will therefore be primarily described below.

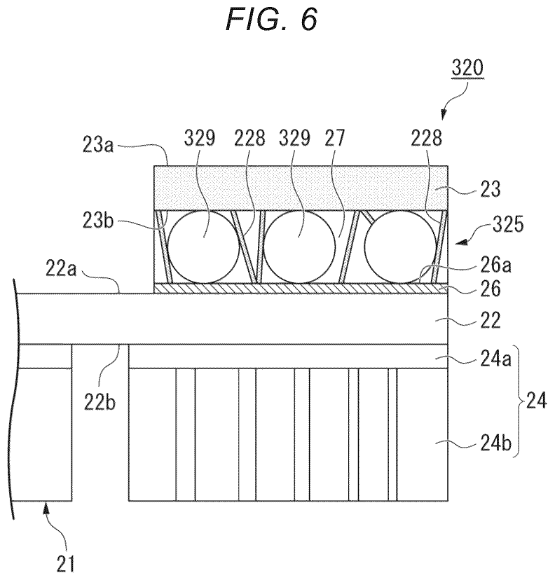

FIG. 6 is an enlarged view showing the configurations of key parts of a wavelength converter 320 according to the present embodiment. In FIG. 6, components common to those in the figures used in the embodiments described above have the same reference characters and will not be described.

The wavelength converter 320 includes the rotation driver 21, the wheel substrate 22, the phosphor 23, the heat dissipation member 24, and a bonding layer 325, as shown in FIG. 6.

The bonding layer 325 in the present embodiment includes the adhesive 27, the plurality of first fillers 228, and a plurality of second fillers 329 having a reflectance higher than that of the first fillers 228. The plurality of second fillers 329 each have a spherical shape.

In the present embodiment, the outer diameter of each of the second fillers 329 is equal to the thickness of the bonding layer 325. The second fillers 329 are sandwiched between the rear surface 23b of the phosphor 23 and the reflection surface 26a.

In the wavelength converter 320 according to the present embodiment, in which the outer diameter of each of the second fillers 329 is equal to the thickness of the bonding layer 325, pressurizing and bonding the phosphor 23 to the bonding layer 325 can control the thickness of the adhesive 27 to be a desired value.

### Fifth Embodiment

The wavelength converter according to a fifth embodiment will be described below.

The basic configuration of the wavelength converter according to the fifth embodiment is the same as that in the first embodiment, but the configuration of the bonding layer differs from that in the first embodiment. The configuration of the bonding layer will therefore be primarily described below.

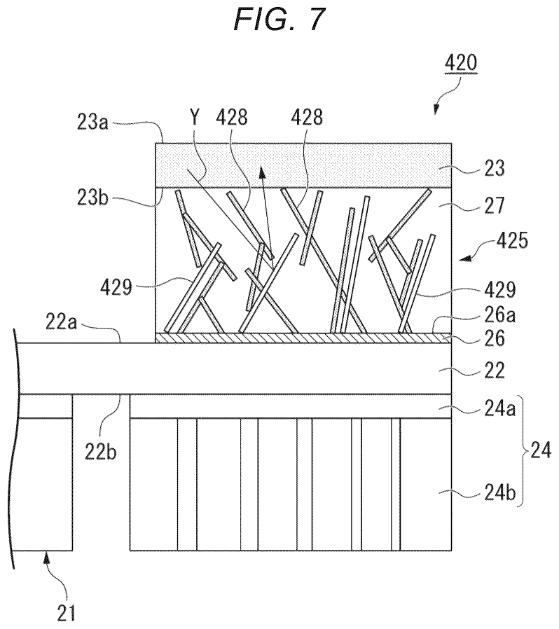

FIG. 7 is an enlarged view showing the configurations of key parts of a wavelength converter 420 according to the present embodiment. In FIG. 7, components common to those in the figures used in the embodiments described above have the same reference characters and will not be described.

The wavelength converter 420 includes the rotation driver 21, the wheel substrate 22, the phosphor 23, the heat dissipation member 24, and a bonding layer 425, as shown in FIG. 7.

The bonding layer 425 in the present embodiment includes the adhesive 27, a plurality of first fillers 428, and a plurality of second fillers 429 having a reflectance higher than that of the first fillers 428. The plurality of second fillers 429 each have a rod-like shape that is the same as that of each of the first fillers 428. That is, the second fillers 429 each have a longitudinal axis along the longitudinal direction.

The material of the rod-shaped second fillers 429 having excellent reflectivity can, for example, be titanium oxide or alumina (Al₂O₃) shown in Table 1, or beryllium oxide (BeO), which excels in light reflectivity and has high thermal conductivity. Some of the plurality of second fillers 429 are disposed in the adhesive 27 so as to be in contact with some of the first fillers 428.

The plurality of second fillers 429 may overlap with each other in layers in the adhesive 27 to form a fibrous shape as a whole. When the plurality of second fillers 429 have a fibrous shape as described above, using a part of the plurality of second fillers 429 as the thermal paths allows further improvement in the thermal conductivity of the bonding layer 425.

In the thus configured wavelength converter 420 according to the present embodiment, the first fillers 428 having excellent thermal conductivity ensure the thermal paths, and mixing the second fillers 429 having excellent light reflectivity and thermal conductivity with the first fillers 428 allows an increase in the efficiency at which the fluorescence Y is extracted. The wavelength converter 420 according to the present embodiment can therefore efficiently extract the fluorescence to generate bright illumination light even when the rod-shaped or fibrous first fillers 428 and second fillers 429 are used.

### Sixth Embodiment

The wavelength converter according to a sixth embodiment will be described below.

The basic configuration of the wavelength converter according to the sixth embodiment is the same as that in the first embodiment, but the configuration of the bonding layer differs from that in the first embodiment. The configuration of the bonding layer will therefore be primarily described below.

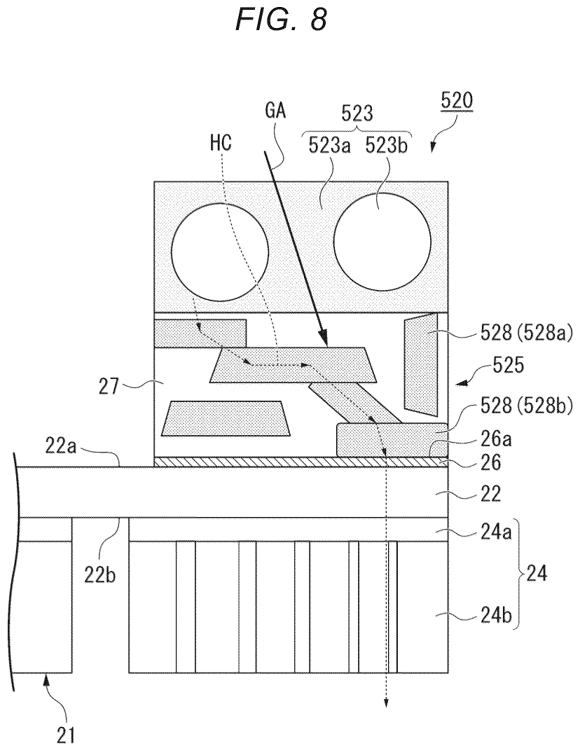

FIG. 8 is an enlarged view showing the configurations of key parts of a wavelength converter 520 according to the present embodiment. In FIG. 8, components common to those in the figures used in the embodiments described above have the same reference characters and will not be described.

The wavelength converter 520 includes the rotation driver 21, the wheel substrate 22, a phosphor 523, the heat dissipation member 24, and a bonding layer 525, as shown in FIG. 8.

The phosphor 523 in the present embodiment has a structure in which a plurality of phosphor particles 523b are dispersed in a binder 523a, unlike the phosphor 23 formed of a ceramic phosphor in the embodiments described above. The binder 523a is made of resin. The phosphor particles 523b are formed, for example, of YAG:Ce particles.

The bonding layer 525 in the present embodiment includes the adhesive 27 and a plurality of first fillers 528 mixed with the adhesive 27. The plurality of first fillers 528 each have a plate-like shape. In the present embodiment, the plurality of first fillers 528 include fillers 528a in contact with the phosphor 523 and fillers 528b in contact with the wheel substrate 22. Some of the plurality of first fillers 528 are arranged so as to be in contact with each other in the thickness direction in the adhesive 27. The plurality of first fillers 528 thus constitute the thermal paths HC, along which the heat of the phosphor 523 is transferred to the wheel substrate 22, inside the bonding layer 525.

In the wavelength converter 520 according to the present embodiment, the phosphor 523 is not a ceramic phosphor but has the structure in which the phosphor particles 523b are dispersed in the binder 523a made of resin. In the present embodiment, the phosphor 523 has a low gas blocking characteristic as compared with those in the configurations of the other embodiments, so that there is a concern about entry of the air having passed through the binder 523a into the bonding layer 525. For example, when the Ag film that constitutes the reflection layer 26 reacts with sulfur dioxide contained in the air, the reaction causes discoloration of the Ag film and turns the color thereof into black, resulting in a decrease in the reflectance thereof.

In contrast, in the wavelength converter 520 according to the present embodiment, coating the reflection layer 26 with the bonding layer 525, in which the plurality of plate-shaped first fillers 528 are contained in the adhesive 27, can improve the gas blocking characteristic of the phosphor 23, which represents the degree of suppression of entry of a gas GA into the reflection layer 26 formed of the Ag film. The wavelength converter 520 can therefore be a highly reliable wavelength converter that suppresses a decrease in reflectance due to the discoloration of the reflection layer 26 and extracts bright fluorescence over a prolonged period of time.

### Seventh Embodiment

The wavelength converter according to a seventh embodiment will be described below.

The basic: configuration of the wavelength converter according to the seventh embodiment is the same as that in the first embodiment, but the configuration of the bonding layer differs from that in the first embodiment. The configuration of the bonding layer will therefore be primarily described below.

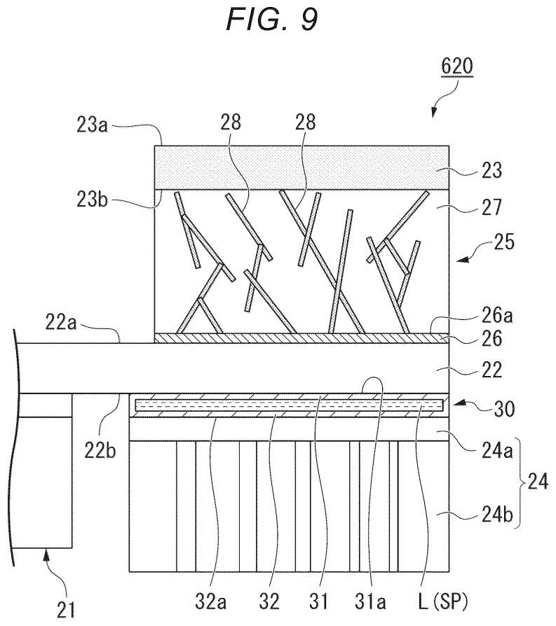

FIG. 9 is an enlarged view showing the configurations of key parts of a wavelength converter 620 according to the present embodiment. In FIG. 9, components common to those in the figures used in the embodiments described above have the same reference characters and will not be described.

The wavelength converter 620 includes the rotation driver 21, the wheel substrate 22, the phosphor 23, the heat dissipation member 24, the bonding layer 25, and a heat diffusion member 30, as shown in FIG. 9.

The heat diffusion member 30 is disposed at the rear surface 22b of the wheel substrate 22 and receives the heat of the wheel substrate 22. The wavelength converter 620 according to the present embodiment includes a phosphor support 50 formed of the heat diffusion member 30 and the wheel substrate 22.

In the present embodiment, the heat dissipation member 24 is provided at the heat diffusion member 30 of the phosphor support 50, and dissipates the heat of the wheel substrate 22 by dissipating the heat of the heat diffusion member 30 to increase the heat diffusion performance of the heat diffusion member 30.

The heat diffusion member 30 is what is called a vapor chamber, and includes a heat receiving plate 31, which supports the rear surface 22b of the wheel substrate 22, and a heat dissipation plate 32 provided at the side opposite from the heat receiving plate 31. The heat diffusion member 30 includes a heat receiver 31a, which receives the heat from the wheel substrate 22, a heat dissipater 32a, which dissipates the heat received by the heat receiver 31a to the heat dissipation member 24, and a housing compartment SP, which hermetically houses a working fluid L as a refrigerant.

The heat receiver 31a is provided at the surface of the heat receiving plate 31 that is opposite from the housing compartment SP. The heat receiver 31a uses the heat at the rear surface 22b of the wheel substrate 22 to vaporize the working fluid L in a liquid form.

The heat dissipater 32a is provided at the surface of the heat dissipation plate 32 that is opposite from the housing compartment SP. The heat dissipater 32a dissipates the heat of the gaseous working fluid L flowing in the housing compartment SP to condense the working fluid L back into the working fluid L in a liquid form. The heat dissipation member 24 is provided at the portion of the outer surface of the heat dissipation plate 32 that corresponds to the heat dissipater 32a.

In the present embodiment, the thermal conductivity of the phosphor support 50 including the vapor chamber is as high as 20000 W/m·K. The thermal conductivity of the phosphor support 50 is therefore higher than the thermal conductivity of the first fillers 28 contained in the bonding layer 25. The heat of the bonding layer 25 is therefore efficiently transferred to the phosphor support 50.

The wavelength converter 620 according to the present embodiment, which includes the phosphor support 50 having thermal conductivity higher than that of the first fillers 28 so that the phosphor 23 is efficiently cooled, can increase the wavelength conversion efficiency of the phosphor 23 to generate brighter fluorescence Y.

The technical scope of the present disclosure is not limited to the embodiments described above, and a variety of changes can be made thereto without departing from the intent of the present disclosure.

The bonding layer may not be provided with the reflection layer 26 but may only contain reflective fillers.

In addition to the above, the specific descriptions of the shape, the number, the arrangement, the material, and other factors of the components of the wavelength converter, the light source apparatus, and the projector are not limited to those in the embodiments described above and can be changed as appropriate. The aforementioned embodiments have been described with reference to the case where the projector according to the present disclosure is a projector using liquid crystal light valves, but not necessarily. The projector according to the present disclosure may have a configuration using digital micromirror devices as the light modulators. The projector may not include a plurality of light modulators and may instead include only one light modulator.

In the embodiments described above, the surface of each of the first fillers may be coated with a film having light reflectivity by using, for example, painting, plating, or vapor deposition.

The wavelength converters according to the embodiments described above are each a reflective wavelength converter that outputs fluorescence toward the side on which the excitation light is incident, and the present disclosure is also applicable to a transmissive wavelength converter that outputs fluorescence in the direction away from the side on which the excitation light is incident.

The wavelength converters according to the aforementioned embodiments have been described with reference to the rotary configuration in which the wheel substrate is rotated to temporally change the position where the excitation light is incident on the phosphor, and the present disclosure may be applied to an immobile wavelength converter in which the position where the excitation light is incident on the phosphor does not change with time.

The present disclosure will be summarized below as additional remarks.

### Additional Remark 1

A wavelength converter including
a phosphor irradiated with excitation light,
a substrate having a first surface, and
a bonding layer that bonds the phosphor to the first surface of the substrate,
the bonding layer including an adhesive and a plurality of first fillers mixed with the adhesive and each having a longitudinal axis,
the plurality of first fillers being so oriented that the direction along the longitudinal axis of each of the first fillers intersects with the first surface of the substrate, and
the thermal conductivity of the first fillers being higher than the thermal conductivity of the adhesive.

According to the wavelength converter described in the additional remark 1, the plurality of first fillers can form thermal paths extending from the phosphor to the wheel substrate in the bonding layer. When thermal paths are formed in the bonding layer by increasing the filling rate of the spherical fillers as in the related art, the amount of the adhesive decreases, which may lower the strength of adhesion provided by the bonding layer, so that the phosphor may peel off the bonding layer or break.

In contrast, the configuration described in the additional remark 1, in which the thermal paths are efficiently formed by aligning the orientation of the longitudinal axis of each of the first fillers with the thickness direction of the bonding layer, can provide a sufficient bonding strength without reduction in the amount of the adhesive.

The present configuration, in which the phosphor is stably held and efficiently cooled, can therefore increase the wavelength conversion efficiency of the phosphor to generate bright fluorescence.

### Additional Remark 2

The wavelength converter described in the additional remark 1, in which
the plurality of first fillers include fillers in contact with the phosphor and fillers in contact with the substrate.

According to the configuration described in the additional remark 2, the plurality of first fillers can readily form the thermal paths extending from the phosphor toward the wheel substrate.

### Additional Remark 3

The wavelength converter described in the additional remark 1 or 2, in which
the plurality of first fillers are provided upright at the first surface of the substrate or a surface of the phosphor that faces the substrate.

According to the configuration described in the additional remark 3, the lengths of the thermal paths formed by the first fillers in the bonding layer can be minimized. Furthermore, making the lengths of the f fillers substantially equal to each other allows the thickness of the adhesive to be controlled. When the thickness of the bonding layer is thus made uniform, the phosphor can be stably held, and variation in the in-plane heat dissipation characteristics of the phosphor can be suppressed.

### Additional Remark 4

The wavelength converter described in any one of the additional remarks 1 to 3, further including
a heat diffusion member that is disposed at a second surface of the substrate that is opposite from the first surface and receives the heat of the substrate,
the thermal conductivity of a phosphor support formed of the heat diffusion member and the substrate being higher than the thermal conductivity of the first fillers.

The configuration described in the additional remark 4, which includes the phosphor support having thermal conductivity higher than that of the first fillers so that the phosphor is efficiently cooled, can increase the wavelength conversion efficiency of the phosphor to generate brighter fluorescence.

### Additional Remark 5

The wavelength converter described in any one of the additional remarks 1 to 4, in which
the substrate has a reflection surface that is in contact with the bonding layer and reflects light.

According to the configuration described in the additional remark 5, the light can be extracted from the phosphor at increased efficiency.

### Additional Remark 6

The wavelength converter described in any one of the additional remarks 1 to 5, in which
the reflectance of the first fillers is higher than the reflectance of the adhesive.

According to the configuration described in the additional remark 6, the first fillers can not only constitute the thermal paths, but also reflect the fluorescence along with the reflection surface, thereby enhancing the efficiency at which the fluorescence is extracted.

### Additional Remark 7

The wavelength converter described in any one of the additional remarks 1 to 6, in which
the bonding layer further includes a plurality of second fillers having a reflectance higher than the reflectance of the plurality of first fillers.

According to the configuration described in the additional remark 7, the plurality of first fillers ensure the thermal paths, and mixing the plurality of second fillers having a high reflectance with the first fillers allows an increase in the efficiency at which the fluorescence is extracted. The fluorescence can therefore be efficiently extracted, so that bright illumination light can be generated.

### Additional Remark 8

The wavelength converter described in the additional remark 7, in which
the plurality of second fillers each have a spherical shape.

According to the configuration described in the additional remark 8, mixing the spherical second fillers with the elongated first fillers allows reflection of the light in a variety of directions, so that the light reflectance inside the bonding layer can be further improved.

### Additional Remark 9

The wavelength converter described in the additional remark 7 or 8, in which
the content rate of the first fillers is smaller than the content rate of the second fillers in the bonding layer.

The configuration described in the additional remark 9 can achieve a bonding layer that excels in thermal conductivity and light reflectivity and has sufficient bonding strength.

### Additional Remark 10

The wavelength converter described in the additional remark 7 or 8, in which
the outer diameter of each of the second fillers is equal to the thickness of the bonding layer.

According to the configuration described in the additional remark 10, pressurizing and bonding the phosphor to the bonding layer can control the thickness of the adhesive to be a desired value.

### Additional Remark 11

The wavelength converter described in any one of the additional remarks 7 to 10, in which
the second fillers each have a shape having a longitudinal axis.

According to the configuration described in the additional remark 11, the first fillers having excellent thermal conductivity ensure the thermal paths, and mixing the second fillers having excellent light reflectivity and thermal conductivity with the first fillers allows an increase in the efficiency at which the fluorescence is extracted.

### Additional Remark 12

The wavelength converter described in any one of the additional remarks 1 to 11, further including
a heat dissipation member that is disposed at a second surface of the substrate that is opposite from the first surface and dissipates the heat of the substrate.

According to the configuration described in the additional remark 12, the efficiency at which the phosphor is cooled can be further improved by the heat dissipation member.

### Additional Remark 13

The wavelength converter described in any one of the additional remarks 1 to 12, in which
the substrate is a wheel substrate, and
the wavelength converter further includes a rotation driver that rotationally drives the wheel substrate.

The configuration described in the additional remark 13, in which the phosphor rotates along with the wheel substrate, allows the position where the excitation light is incident on the phosphor to be moved with time. Thus increasing the performance of cooling the phosphor suppresses a decrease in the fluorescence conversion efficiency due to an increase in the temperature of the phosphor.

### Additional Remark 14

A wavelength converter including
a phosphor irradiated with excitation light,
a substrate having a first surface, and
a bonding layer that bonds the phosphor to the first surface of the substrate,
the bonding layer being formed of an adhesive and a plurality of first fillers mixed with the adhesive and having at least one of a fibrous shape, a rod-like shape, and a plate-like shape,
the thermal conductivity of the first fillers being higher than the thermal conductivity of the adhesive, and
the plurality of first fillers constituting thermal paths that transfer the heat of the phosphor to the substrate.

The configuration described in the additional remark 14, in which the plurality of first fillers having at least one of a fibrous shape, a rod-like shape, and a plate-like shape efficiently form the thermal paths in the bonding layer, can provide a sufficient bonding strength without reduction in the amount of the adhesive, unlike the case where the spherical fillers are used.

The present configuration, in which the phosphor is stably held and efficiently cooled, can therefore increase the wavelength conversion efficiency of the phosphor to generate bright fluorescence.

### Additional Remark 15

The wavelength converter described in the additional remark 14, in which
the plurality of first fillers include fillers in contact with the phosphor and fillers in contact with the substrate.

According to the configuration described in the additional remark 15, the plurality of first fillers can readily form the thermal paths extending from the phosphor toward the wheel substrate.

### Additional Remark 16

The wavelength converter described in the additional remark 14 or 15, in which
the plurality of first fillers are provided upright at the first surface of the substrate or a surface of the phosphor that faces the substrate.

According to the configuration described in the additional remark 16, the lengths of the thermal paths formed by the first fillers in the bonding layer can be minimized. Furthermore, making the lengths of the first fillers substantially equal to each other allows the thickness of the adhesive to be controlled. When the thickness of the bonding layer is thus made uniform, the phosphor can be stably held, and variation in the in-plane heat dissipation characteristics of the phosphor can be suppressed.

### Additional Remark 17

The wavelength converter described in any one of the additional remarks 14 to 16, further including
a heat diffusion member that is disposed at a second surface of the substrate that is opposite from the first surface and receives the heat of the substrate,
the thermal conductivity of a phosphor support formed of the heat diffusion member and the substrate being higher than the thermal conductivity of the first fillers.

The configuration described in the additional remark 17, which includes the phosphor support having thermal conductivity higher than that of the first fillers so that the phosphor is efficiently cooled, can increase the wavelength conversion efficiency of the phosphor to generate brighter fluorescence.

### Additional Remark 18

The wavelength converter described in any one of the additional remarks 14 to 17, in which
the substrate has a reflection surface that is in contact with the bonding layer and reflects light.

According to the configuration described in the additional remark 18, the light can be extracted from the phosphor at increased efficiency.

### Additional Remark 19

The wavelength converter described in any one of the additional remarks 14 to 18, in which
the reflectance of the first fillers is higher than the reflectance of the adhesive.

According to the configuration described in the additional remark 19, the first fillers can not only constitute the thermal paths, but also reflect the fluorescence along with the reflection surface, thereby enhancing the efficiency at which the fluorescence is extracted.

### Additional Remark 20

The wavelength converter described in any one of the additional remarks 14 to 19, in which
the bonding layer further includes a plurality of second fillers having a reflectance higher than the reflectance of the plurality of first fillers.

According to the configuration described in the additional remark 20, the plurality of first fillers ensure the thermal paths, and mixing the plurality of second fillers having a high reflectance with the first fillers allows an increase in the efficiency at which the fluorescence is extracted. The fluorescence can therefore be efficiently extracted, so that bright illumination light can be generated.

### Additional Remark 21

The wavelength converter described in the additional remark 20, in which
the plurality of second fillers each have a spherical shape.

According to the configuration described in the additional remark 21, mixing the spherical second fillers with the elongated first fillers allows reflection of the light in a variety of directions, so that the light reflectance inside the bonding layer can be further improved.

### Additional Remark 22

The wavelength converter described in the additional remark 20 or 21, in which
the content rate of the first fillers is smaller than the content rate of the second fillers in the bonding layer.

The configuration described in the additional remark 22 can achieve a bonding layer that excels in thermal conductivity and light reflectivity and has sufficient bonding strength.

### Additional Remark 23

The wavelength converter described in the additional remark 20 or 21, in which
the outer diameter of each of the second fillers is equal to the thickness of the bonding layer.

According to the configuration described in the additional remark 23, pressurizing and bonding the phosphor to the bonding layer can control the thickness of the adhesive to be a desired value.

### Additional Remark 24

The wavelength converter described in any one of the additional remarks 20 to 23, in which
the second fillers each have a shape having a longitudinal axis.

According to the configuration described in the additional remark 24, the first fillers having excellent thermal conductivity ensure the thermal paths, and mixing the second fillers having excellent light reflectivity and thermal conductivity with the first fillers allows an increase in the efficiency at which the fluorescence is extracted.

### Additional Remark 25

The wavelength converter described in any one of the additional remarks 14 to 24 further including
a heat dissipation member that is disposed at a second surface of the substrate that is opposite from the first surface and dissipates the heat of the substrate.

According to the configuration described in the additional remark 25, the efficiency at which the phosphor is cooled can be further improved by the heat dissipation member.

### Additional Remark 26

The wavelength converter described in any one of the additional remarks 14 to 25, in which
the substrate is a wheel substrate, and
the wavelength converter further includes a rotation driver that rotationally drives the wheel substrate.

The configuration described in the additional remark 26, in which the phosphor rotates along with the wheel substrate, allows the position where the excitation light is incident on the phosphor to be moved with time. Thus increasing the performance of cooling the phosphor suppresses a decrease in the fluorescence conversion efficiency due to an increase in the temperature of the phosphor.

### Additional Remark 27

A light source apparatus including
the wavelength converter described in any one of the additional remarks 1 to 26, and
an excitation light source that outputs the excitation light toward the wavelength converter.

The light source apparatus described in the additional remark 27 can be a light source apparatus that excels in the wavelength conversion efficiency and outputs the illumination light containing the bright fluorescence.

### Additional Remark 28

A projector including
the light source apparatus described in the additional remark 27,
a light modulator that modulates the light output from the light source apparatus, and
a projection optical apparatus that projects the light modulated by the light modulator.

The projector described in the additional remark 28 can be a highly efficient projector that excels in display quality.

What is claimed is:

1. A wavelength converter comprising:
a phosphor irradiated with excitation light;
a substrate having a first surface; and
a bonding layer that bonds the phosphor to the first surface of the substrate,
wherein the bonding layer includes an adhesive and a plurality of first fillers mixed with the adhesive, each of the first fillers having a longitudinal axis,
the plurality of first fillers are so oriented that a direction along the longitudinal axis of each of the first fillers intersects with the first surface of the substrate, and
a thermal conductivity of the first fillers is higher than a thermal conductivity of the adhesive.

2. The wavelength converter according to claim 1, wherein
the plurality of first fillers include fillers in contact with the phosphor and fillers in contact with the substrate.

3. The wavelength converter according to claim 1, wherein
the plurality of first fillers are provided upright at the first surface of the substrate or a surface of the phosphor that faces the substrate.

4. The wavelength converter according to claim 1, further comprising
a heat diffusion member that is disposed at a second surface of the substrate that is opposite from the first surface and receives heat of the substrate,
wherein a thermal conductivity of a phosphor support formed of the heat diffusion member and the substrate is higher than the thermal conductivity of the first fillers.

5. The wavelength converter according to claim 1, wherein
the substrate has a reflection surface that is in contact with the bonding layer and reflects light.

6. The wavelength converter according to claim 5, wherein
a reflectance of the first fillers is higher than a reflectance of the adhesive.

7. The wavelength converter according to claim 1, wherein
a reflectance of the first fillers is higher than a reflectance of the adhesive.

8. The wavelength converter according to claim 1, wherein
the bonding layer further includes a plurality of second fillers having a reflectance higher than a reflectance of the plurality of first fillers.

9. The wavelength converter according to claim 8, wherein
the plurality of second fillers each have a spherical shape.

10. The wavelength converter according to claim 8, wherein
a content rate of the first fillers is smaller than a content rate of the second fillers in the bonding layer.

11. The wavelength converter according to claim 9, wherein
an outer diameter of each of the second fillers is equal to a thickness of the bonding layer.

12. The wavelength converter according to claim 8, wherein
the second fillers each have a shape having a longitudinal axis.

13. The wavelength converter according to claim 1, further comprising
a heat dissipation member that is disposed at a second surface of the substrate that is opposite from the first surface and dissipates heat of the substrate.

14. The wavelength converter according to claim 1, further comprising
a rotation driver, wherein
the substrate is a wheel substrate, and
the rotation driver rotationally drives the wheel substrate.

15. A wavelength converter comprising:
a phosphor irradiated with excitation light;
a substrate having a first surface; and
a bonding layer that bonds the phosphor to the first surface of the substrate,
wherein the bonding layer is formed of an adhesive and a plurality of first fillers mixed with the adhesive and having at least one of a fibrous shape, a rod-like shape, and a plate-like shape,
a thermal conductivity of the first fillers is higher than a thermal conductivity of the adhesive, and
the plurality of first fillers constitute thermal paths that transfer heat of the phosphor to the substrate.

16. The wavelength converter according to claim 15, wherein
the plurality of first fillers include fillers in contact with the phosphor and fillers in contact with the substrate.

17. The wavelength converter according to claim 15, wherein
the plurality of first fillers are provided upright at the first surface of the substrate or a surface of the phosphor that faces the substrate.

18. The wavelength converter according to claim 15, further comprising
a heat diffusion member that is disposed at a second surface of the substrate that is opposite from the first surface and receives heat of the substrate,
wherein a thermal conductivity of a phosphor support formed of the heat diffusion member and the substrate is higher than the thermal conductivity of the first fillers.

19. A light source apparatus comprising:
the wavelength converter according to claim 1; and
an excitation light source that outputs the excitation light toward the wavelength converter.

20. A projector comprising:
the light source apparatus according to claim 19;
a light modulator that modulates light emitted from the light source apparatus; and
a projection optical apparatus that projects the light modulated by the light modulator.
